(19) United States
(12) Patent Application Publication
(10) Pub. No.: US 2026/0225532 A1
(43) Pub. Date: Aug. 6, 2026

(54) Sliding Step

(71) Applicant: Harry Ernst Sorensen Midgley, Brackendale (CA)

(72) Inventor: Harry Ernst Sorensen Midgley, Brackendale (CA)

(21) Appl. No.: 19/636,646

(22) Filed: Apr. 1, 2026

Related U.S. Application Data
(63) Continuation of application No. 19/038,266, filed on Jan. 27, 2025, now Pat. No. 12,623,605.
(60) Provisional application No. 63/625,788, filed on Jan. 26, 2024.

(51) Int. Cl. B60R 3/00

(52) U.S. Cl. CPC B60R 3/007

(57) ABSTRACT

A foot step device for vehicles, comprising a body member with a cantilever-style design configured to mount onto stock rock slider rails without requiring additional hardware or tools. The body includes a contoured aperture for snap-fit engagement, parallel ridges for grip, and smooth transitions for ergonomic use and safety. The device is adjustable along the rails, reinforced with internal ribs and recesses for structural integrity, and fabricated from lightweight, durable materials. Optimized for off-road and utility vehicles, it provides a non-invasive, adaptable, and space-efficient stepping solution.

### FIELD OF THE INVENTION

The present invention relates to vehicle accessories, and more specifically to a foot step device designed to be mounted on the stock rock slider rails of a Chevrolet Colorado ZR2 for ease of access to the vehicle.

### BACKGROUND OF THE INVENTION

Vehicles, such as trucks and off-road vehicles like the Chevrolet Colorado ZR2, are often positioned higher off the ground, making it challenging for individuals to enter and exit the vehicle.

Various solutions have been developed, including fixed steps, retractable steps, and aftermarket step accessories. However, these solutions often present drawbacks, such as complicated installation processes, added vehicle weight, and limited flexibility in step positioning to meet user preferences.

Many existing steps are constructed from heavy materials like steel or aluminum, which can significantly increase the vehicle's weight. This added weight may reduce fuel efficiency and negatively impact performance, particularly in off-road environments.

Additionally, installation of these steps often requires drilling or other permanent modifications to the vehicle's body or frame. Such modifications may be undesirable for vehicle owners or leaseholders who want to preserve the vehicle's original condition.

Furthermore, most currently available steps are fixed in position after installation, preventing users from adjusting the step to their preferred location. This lack of adjustability can be inconvenient for users of different heights, physical abilities, or for situations where varying terrains require different step positions for safe and convenient access.

Accordingly, there is a need for an improved vehicle step, particularly for vehicles like the Chevrolet Colorado ZR2, that is lightweight, easy to install without requiring permanent modifications, adjustable in position, and made from durable materials capable of withstanding the demanding conditions of off-road use.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a clip-on foot step designed to attach to the stock rock slider rails of the Chevrolet Colorado ZR2 or similar vehicles. This foot step is lightweight, adjustable, and requires no additional hardware or tools for installation.

The foot step includes a body member with an aperture that acts as a clip, allowing it to attach to the rock slider rails. The design uses a cantilever-style structure, which extends horizontally and is unsupported at one end, relying on the rock slider rails for stability. The body member features smooth edges and transitions for ergonomic use and safety.

The foot step is made from PETG-CF, a composite material combining polyethylene terephthalate glycol-modified (PETG) and carbon fibers. This material provides strength and durability while keeping the step lightweight (approximately 0.5 kilograms), ensuring minimal impact on vehicle performance and fuel efficiency.

The invention is easy to install and adjust, allowing users to position the step along the rock slider rails to their preferred position. It can be quickly attached or removed without tools, making it ideal for temporary use or for removal during off-road activities.

In some embodiments, the foot step includes a horizontal platform as the step surface, with rectangular recesses and protrusions for reinforcement. The rear of the step may feature parallel ridges for grip and mounting. Certain designs may also include a clip mechanism for secure attachment and easy detachment.

This invention offers a practical, user-friendly, and non-invasive solution for adding a foot step to off-road and utility vehicles, addressing the limitations of conventional steps by providing a lightweight, adjustable, and removable option.

### BRIEF DESCRIPTION OF THE DRAWINGS

FIG. 1 Perspective view of a Generation 2 high-step for a Chevrolet Colorado ZR2, comprising a wedge-shaped body member having a platform surface including a plurality of ridges configured to provide traction, a vertical member extending between the platform surface and a rail engagement portion, and a contoured aperture formed in the rail engagement portion, wherein the rail engagement portion includes a recessed region formed within the aperture geometry and configured to modify friction, retention, or engagement characteristics with a vehicle rail.

FIG. 2 Side view of a Generation 2 high-step for a Chevrolet Colorado ZR2, comprising a wedge-shaped body member having a platform surface, a vertical member extending downward from the platform surface and including a plurality of ridges, and a rail engagement portion including a contoured aperture, wherein the body member forms a cantilevered structure extending outward from the rail engagement portion.

FIG. 3 Perspective view of a lowered step for a Generation 3 Chevrolet Colorado ZR2, comprising a body member having a platform surface including a plurality of ridges configured to provide traction, a rail engagement portion including a contoured aperture configured to capture a rail of a vehicle, and a vertical member extending upward from the body member, the vertical member being positioned to contact or bear against a second rail of the vehicle to provide stabilizing support.

FIG. 3A Side view of the lowered step of FIG. 3, comprising a body member having a rail engagement portion including a contoured aperture configured to capture a rail of a vehicle, and a vertical member extending upward from the body member, the vertical member being positioned to contact or bear against a second rail of the vehicle to provide stabilizing support.

FIG. 4 Perspective view of a step device comprising a body member having a platform surface including a plurality of ridges configured to provide traction and dual rail engagement portions configured to capture respective rails and removably mount the step device without requiring tools or hardware, the body member further including a rear surface having a plurality of pre-formed openings configured to permit optional installation of secondary retention or securing elements.

FIG. 5 Side view of a Generation 3 high-step for a Chevrolet Colorado ZR2, comprising a wedge-shaped body member having a platform surface including a plurality of ridges configured to provide traction, and a rail engagement portion including a contoured interface having multiple radii and a region of reduced curvature forming a near-planar segment within a chordal region, the rail engagement portion being configured for sequential hook-and-clip engagement with a rail or rail structure of the vehicle.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. Any embodiment may incorporate one or more of the above-disclosed aspects of the disclosure and may further incorporate one or more of the above-disclosed features. Furthermore, any embodiment discussed and identified as being “preferred” is considered to represent a best mode contemplated for carrying out the embodiments of the present disclosure. Other embodiments may also be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more examples, it is to be understood that this disclosure is illustrative and exemplary of the present disclosure, and is made merely for the purposes of providing a full and enabling disclosure. The detailed disclosure herein is not intended, nor is it to be construed, to limit the scope of patent protection afforded in any claim of a patent issuing herefrom, which scope is to be defined by the claims and the equivalents thereof. It is not intended that the scope of patent protection be defined by reading into any claim limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from a particular dictionary definition of such term, it is intended that the meaning of the term as understood by the ordinary artisan should prevail.

Furthermore, it is important to note that, as used herein, “a” and “an” each generally denote “at least one,” but do not exclude a plurality unless the contextual use dictates otherwise. When used herein to join a list of items, “or” denotes at least one of the items, but does not exclude a plurality of items in the list. Finally, when used herein to join a list of items, “and” denotes all of the items in the list.

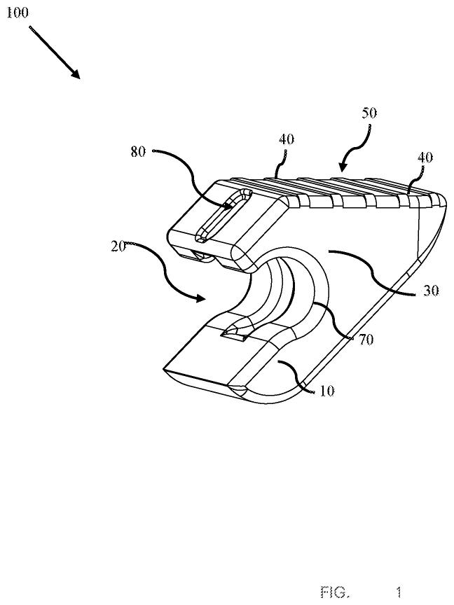

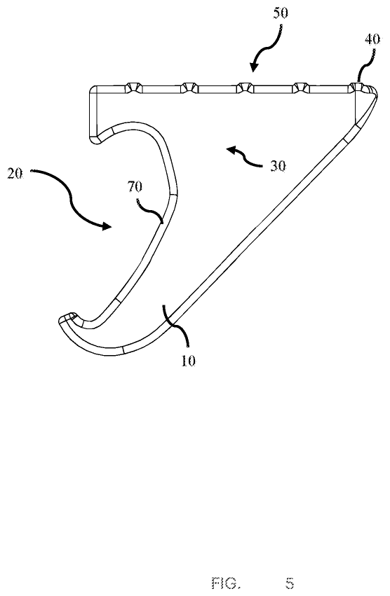

The present invention provides a clip-on foot step designed to mount on rock slider rails along the lower body of a vehicle without requiring tools or additional hardware for primary installation. FIGS. 1-5 illustrate embodiments of the invention, including high and low step variants comprising a body member 10 having a contoured aperture configured to capture a rail through snap-fit engagement. The body member 10 forms a cantilever-style foot step support 30 characterized by ease of installation and adjustability, allowing users to reposition the step device along the rock slider rails to a position that suits their individual preference.

In some embodiments, the present invention may include a contoured body with a main horizontal platform 50 forming a step surface. This platform may lead into a curved structure (aperture 20) configured to permit repositioning of the step device along the rail after installation. In some embodiments, the present invention may include one or more rectangular recesses 80 in the body member, as shown in FIG. 1, and protrusions configured to provide structural reinforcement or to modify engagement characteristics. The present invention may include a plurality of parallel ridges 40 configured to provide grip. In preferred embodiments, the design is ergonomic, with smooth transitions and rounded edges to ensure safety and space efficiency.

In some embodiments, the body member or components thereof may be fabricated from metallic materials, including steel, aluminum, or other structural metals, or from composite or polymer materials having varying degrees of rigidity or elasticity. In certain configurations, the rail engagement portion may be formed as a multi-component assembly, including separate members configured to cooperate to achieve snap-fit engagement, sequential engagement, or other removable mounting behavior. Such configurations may rely on mechanical interaction between components rather than relying solely on material elasticity of a single body member.

In preferred embodiments, the foot step 100 of the present invention is fabricated from a polymer composite material, including polyethylene terephthalate glycol-modified (PETG) reinforced with carbon fiber (CF), or other materials providing similar strength and durability characteristics.

Unlike conventional steps, the proposed foot step 100 does not require tools or additional hardware for primary installation, allowing the step device to be removably mounted to a vehicle rail. The design allows for quick attachment and detachment from the vehicle, providing versatility and convenience for users who may only need a step occasionally or wish to remove it for off-road activities.

In one embodiment, the present invention includes a cantilever structure 30 comprising a rigid structural element extending horizontally from the rail engagement portion and unsupported at one end. The cantilever structure ensures that the step 100 is held in place by leveraging the structure of the rock slider rails without the need for drilling or permanent fixtures. This approach addresses the need for a non-invasive, adaptable, and lightweight foot step solution for vehicles such as the Chevrolet Colorado ZR2 and other vehicles with similar rail configurations.

The spatial separation between the lower rail engagement portion and the vertical member permits the step device to capture a first rail while contacting a second rail, thereby enabling multiple step devices to be positioned along adjacent rails without requiring removal of previously installed devices.

In some embodiments, an aperture may be formed along an upper portion of the vertical member and configured to capture an upper rail of the vehicle, allowing the step device to be supported by the upper rail while maintaining clearance relative to a lower rail.

In preferred embodiments, the step device is configured to be installed onto the vehicle rails without requiring tools or hardware, while optionally accommodating secondary retention elements when additional security or stability is desired.

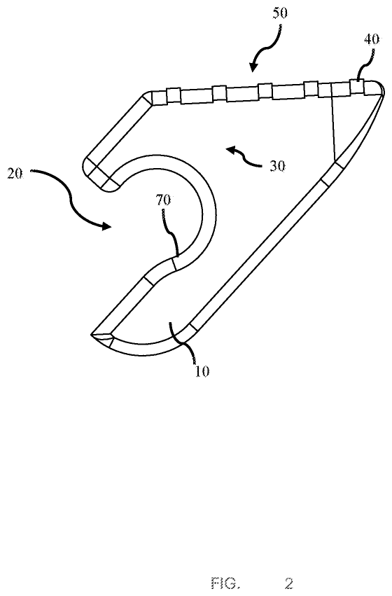

In one embodiment, as shown in FIGS. 1-2, the present invention provides a foot step device 100 for a vehicle, comprising:
a body member 10 configured to mount onto rock slider rails of a vehicle without requiring tools or additional hardware;
a contoured aperture formed in the body member 10 and configured to function as an integrated clip mechanism for removable engagement to the rock slider rails;
a cantilever structure 30 of the body member 10, wherein the foot step device 100 extends horizontally and is unsupported at one end; and
wherein the body member 10 includes smooth transitions and rounded edges to ensure ergonomic use, safety, and space efficiency.

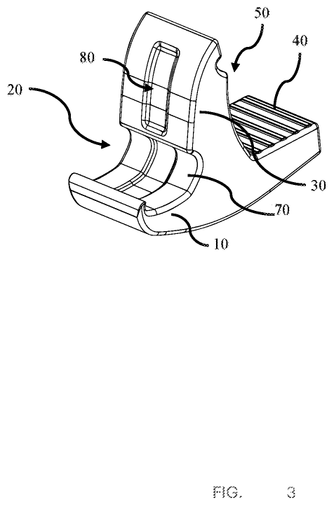

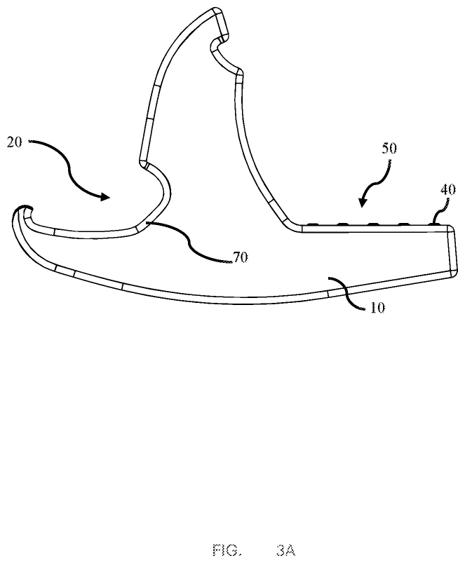

In another embodiment, as shown in FIG. 3, the present invention provides a foot step device 100 for a vehicle, comprising:
a contoured body member 10 with a main horizontal platform 50 configured as a step surface;
wherein the platform 50 includes an angled portion and a vertical member configured to provide stabilization relative to a second rail;
a curved structure 20 extending from the platform 50 and forming a rail engagement portion configured to capture a rail of the vehicle;
one or more rectangular recesses 80 and/or protrusions on the horizontal platform 50 configured to provide structural reinforcement or to modify engagement characteristics; and
a plurality of parallel ridges 40 on the platform 50 configured to provide grip for the user.

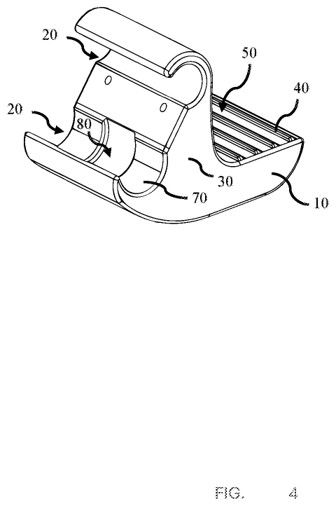

In another embodiment, as shown in FIG. 4, the present invention provides a foot step device 100 for a vehicle, comprising:
a body member 10 configured to mount onto rock slider rails of a vehicle without requiring drilling or permanent fixtures;
dual rail engagement portions configured to capture respective rails of the vehicle;
a platform 50 having an angled portion;
a cantilever structure 30 configured to leverage the rock slider rails to support the step device 100; and
an integrated clip mechanism formed within at least one contoured aperture and configured to engage and disengage the vehicle rail.

The body member 10 may further include one or more pre-formed openings configured to permit optional installation of secondary retention or securing elements without compromising the structural integrity of the body member.

In some embodiments, the body member 10 may include a detachable aperture-defining structure configured to modify engagement characteristics with the rail.

The present invention therefore represents a significant advancement in the field of vehicle accessories, particularly for off-road and utility vehicles, by providing a practical, user-friendly, and efficient foot step solution.

Although the invention has been explained in relation to preferred embodiments, it is to be understood that many other possible modifications and variations may be made without departing from the spirit and scope of the invention.

What is claimed is:

1. A foot step device for a vehicle, comprising:
a body member configured to removably mount onto a rocker panel guard of the vehicle by snap-fit engagement of an integrated clip mechanism, without requiring additional hardware or tools;
the body member comprising an aperture having a chordal opening sized to receive an edge of the rocker panel guard, the aperture being integrally formed in the body member and configured to function as a resilient clip for attachment to the rocker panel guard; and
a cantilever-style design in the body member, wherein, when mounted, the body member extends horizontally from the rocker panel guard and is unsupported at a free distal end.

2. The foot step device of claim 1, wherein the body member includes at least one detachable contoured aperture.

3. The foot step device of claim 2, wherein the body member comprises at least one platform.

4. The foot step device of claim 3, wherein the cantilever-style design is configured to distribute weight across the rock slider rails.

5. The foot step device of claim 1, wherein the aperture includes a contoured profile to ensure a snug fit around the rocker panel guards.

6. The foot step device of claim 1, wherein the body member is fabricated using an additive manufacturing process to achieve precise tolerances and lightweight construction.

7. The foot step device of claim 1, wherein the body member includes smooth transitions between surfaces and rounded edges, the smooth transitions reducing stress concentrations and improving structural integrity, and the rounded edges minimizing sharp corners to enhance user safety and prevent accidental injury during use.

8. The foot step device of claim 1, wherein the body member is dimensioned and contoured to fit the rocker panel guards of the Chevrolet Colorado ZR2.

9. The foot step device of claim 3, wherein the body member is constructed from a lightweight, durable material resistant to corrosion and impact.

10. The foot step device of claim 1, wherein the body member includes one or more pre-formed openings configured to receive an optional retention element without modifying the body member.

11. A foot step device for a vehicle, comprising: a contoured body member with a main horizontal platform configured as a step surface; wherein the main horizontal platform includes an angled portion; one or more rectangular recesses and protrusions on the main horizontal platform; and a plurality of parallel ridges in the contoured body member, configured to provide grip for the user; wherein the contoured body member is fabricated from PETG-CF material, a composite of polyethylene terephthalate glycolmodified (PETG) and carbon fibers, to provide strength, durability, and lightweight characteristics.

12. The foot step device of claim 11, wherein the main horizontal platform includes: one or more rectangular recesses and protrusions for reinforcement or engagement with other parts of the mechanism, enhancing structural rigidity and stability.

13. The foot step device of claim 12, wherein the PETG-CF material is configured to provide resistance to environmental factors including UV radiation, moisture, and temperature fluctuations.

14. The foot step device of claim 12, wherein the recesses on the main horizontal platform are configured to reduce material weight while maintaining structural integrity.

15. The foot step device of claim 13, wherein the plurality of parallel ridges are spaced evenly to enhance grip and provide additional structural support.

16. A foot step device for a vehicle, comprising: a body member configured to mount onto a rocker panel guard of a vehicle by snap-fit engagement without requiring drilling or permanent fixtures, where the body member is made of lightweight material; at least one contoured aperture in the body member configured to clip onto the rocker panel guard; a platform having an angled portion and a vertical surface; a cantilever-style design that leverages the rocker panel guard to support the foot step device without additional hardware; and an integrated clip mechanism within the contoured aperture, configured to engage and disengage the rocker panel guard.

17. The foot step device of claim 16, wherein the body member includes at least one detachable contoured aperture.

18. The foot step device of claim 17, wherein the cantilever-style design includes reinforcement ribs to increase load-bearing capacity.

19. The foot step device of claim 17, wherein the body member is dimensioned to remain within the lateral and vertical clearance of the vehicle's rocker panel guard, ensuring that the foot step device does not protrude excessively or interfere with the vehicle's off-road capabilities, ground clearance, or overall aesthetics.

20. The foot step device of claim 18, wherein the integrated clip mechanism comprises a clip or locking mechanism integrated into the contoured aperture, allowing the foot step device to be attached or detached without requiring tools, enabling easy removal for off-road use or temporary applications.

21. A foot step device for a vehicle, comprising:
a body member configured to removably mount onto a rail of the vehicle without requiring tools or additional hardware;
a rail engagement portion formed in the body member and including a contoured aperture configured to receive the rail;
wherein the rail engagement portion is configured to engage the rail through a sequential, non-linear capture path involving a change in relative position between the body member and the rail during installation; and
wherein the body member forms a cantilever structure extending outward from the rail when mounted.

22. The foot step device of claim 21, wherein engagement of the rail occurs through rotation or translation of the body member relative to the rail during installation.
